(19) United States
(12) Patent Application Publication
(10) Pub. No.: US 2006/0115740 A1
(43) Pub. Date: Jun. 1, 2006

(54) Hologram recording medium

(75) Inventors: Rumiko Hayase, Yokohama-shi (JP); Akiko Hirao, Chiba-shi (JP); Norikatsu Sasao, Tokyo (JP); Takayuki Tsukamoto, Kawasaki-shi (JP); Kazuki Matsumoto, Kawasaki-shi (JP)

Correspondence Address: NIXON & VANDERHYE, PC, 901 NORTH GLEBE ROAD, 11TH FLOOR, ARLINGTON, VA, 22203, US

(73) Assignee: KABUSHIKI KAISHA TOSHIBA, Tokyo (JP)

(21) Appl. No.: 11/285,196

(22) Filed: Nov. 23, 2005

(30) Foreign Application Priority Data
Nov. 26, 2004 (JP) P.2004-342270

(51) Int. Cl. G03H 1/04

(52) U.S. Cl. 430/1; 430/2; 359/3

(57) ABSTRACT

A hologram recording medium includes: first and second translucent substrates; and a recording layer, which is formed between the first and second substrates, contains a three-dimensionally crosslinked polymer matrix, a radical polymerizable compound and a photoradical polymerization initiator, shows a rubber-like elasticity at the room temperature, and has a durometer hardness within a range of A45 to A85.

The present application claims foreign priority based on Japanese Patent Application No. JP2004-342270 filed on Nov. 26, 2004, the contents of which is incorporated herein by reference.

### BACKGROUND OF THE INVENTION

The present invention relates to a volumic hologram recording medium executing recording and reproduction with a light.

A hologram recording medium executing recording and reproduction with light is one of optical recording technologies realizing a higher capacity and a higher-speed transfer in comparison for example with a magnetooptical recording medium or a phase-change optical recording medium, and is now under active research and development.

In particular, a volumic hologram recording medium is expected, because of a high diffraction efficiency, as a medium capable of realizing a high recording density.

Under irradiation with a recording light and a reference light in a recording operation, interference fringes constituted of light areas and dark areas are formed in a recording layer of the volumic hologram recording medium. In a light area, a photopolymerization reaction proceeds by a radical polymerizable compound that is activated by a photoradical polymerization initiator, and, in a dark area, the radical polymerizable compound diffuses toward the light area. Thus, a distribution in the concentration of the radical polymerizable compound is generated according to the intensity of the interference fringes. The volumic hologram recording medium holds a distribution of refractive index, associated with such distribution in the concentration of the radical polymerizable compound as recorded information.

As a recording layer for such volumic hologram recording medium, there is known a configuration including a three-dimensionally crosslinked polymer matrix in addition to the radical polymerizable compound and the photoradical polymerization initiator as disclosed in JP-A No. 11-352303. However, this document does not disclose an aliphatic acid anhydride.

The three-dimensionally crosslinked polymer matrix serves to suppress an excessive movement of the radical polymerizable compound, and also to suppress a volumic change in a region corresponding to the light area and a region corresponding to the dark area in the recording layer. The three-dimensionally crosslinked polymer matrix can be formed, for example, by a cured reaction product derived from an epoxy compound (cf T. J. Trentler, J. E. Boid and V. L. Colvin, Epoxy-Photopolymer Composition: Thick Recording Media for Holographic Data Storage, Proceedings of SPIE, 2001, Vol. 4296, pp 259-266.). However, this cured reaction product is not a cured reaction product of the epoxy compound and an aliphatic acid anhydride.

At present, a higher recording sensitivity and a higher diffraction efficiency are desired for the volumic hologram recording medium.

### SUMMARY OF THE INVENTION

According to one illustrative, non-limiting embodiment of the present invention, a hologram recording medium is provided and include: first and second translucent substrates; and a recording layer, which is formed between the first and second substrates, contains a three-dimensionally crosslinked polymer matrix, a radical polymerizable compound and a photoradical polymerization initiator, shows a rubber-like elasticity at the room temperature, and has a durometer hardness within a range of A45 to A85.

According to another illustrative, non-limiting embodiment of the present invention, a hologram recording medium is provided and includes: first and second translucent substrates; and a recording layer, which is formed between the first and second substrates, contains: a three-dimensionally crosslinked polymer matrix containing a cured reaction product of a diglycidyl ether having an epoxy equivalent of 100 to 300 and an aliphatic acid anhydride; a radical polymerizable compound; and a photoradical polymerization initiator.

According to another illustrative, non-limiting embodiment of the present invention, a hologram recording medium is provided and includes: first and second translucent substrates; and a recording layer, which is formed between the first and second substrates, contains: a three-dimensionally crosslinked polymer matrix including a cured reaction product of a diglycidyl ether and an aliphatic acid anhydride; a radical polymerizable compound; and a photoradical polymerization initiator, shows a rubber-like elasticity at the room temperature, and has a durometer hardness of A45 to A85.

The present invention can provide a hologram recording medium having a high recording sensitivity and a high diffraction efficiency.

### BRIEF DESCRIPTION OF THE DRAWINGS

FIG. 1 is a schematic cross-sectional view showing an example of a transmission hologram recording medium to be employed in a two-beam holography and also showing a recording light and a reference light in the vicinity.

FIG. 2 is a schematic cross-sectional view showing an example of a reflective hologram recording medium to be employed in a collinear holography and also showing a recording light and a reference light in the vicinity.

FIG. 3 is a schematic view showing a reaction of diglycidyl ether and an aliphatic acid anhydride.

FIG. 4 is a view showing an example of an angle-diffraction efficiency relationship in an angular multiplex recording/reproduction test.

### DETAILED DESCRIPTION OF THE INVENTION

In the following, exemplary embodiments of the present invention will be explained with reference to the accompanying drawings. Throughout the embodiments, common configurations are represented by a same symbol and will not be explained in duplication. Also the drawings are schematic views for explaining the invention and promoting understanding thereof, and may be different from an actual apparatus in a shape, a dimension and a ratio, but these points may be suitably altered referring to the following description and to known technologies.

In this application, the room temperature indicates 25° C. Also rubber-like elasticity means a specific elasticity exhibited by rubber and a rubber-like substance (cf Iwanami Rikagaku Jiten, 5th edit.).

### FIRST EMBODIMENT

In the following, there will be explained a hologram recording medium of a first embodiment.

The hologram recording medium of a first embodiment includes first and second substrates, and a recording layer formed between the first and second substrates. In addition, the hologram recording medium may be suitably provided with a reflective layer, an intermediate layer, a protective layer, a spacer and the like as will be explained later.

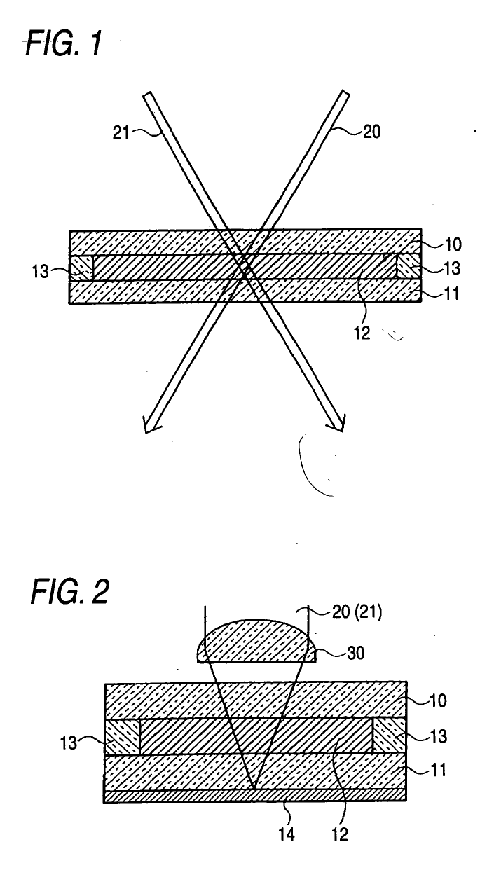

FIG. 1 is a schematic cross-sectional view showing an example of a transmission type hologram recording medium to be employed in a two-light beam holography, and a recording light and a reference light in the vicinity thereof A transmission hologram recording medium is provided, as shown in FIG. 1, with a first substrate 10 and a second substrate 11, a spacer 13 supported therebetween, and a recording layer 12 surrounded by the spacer 13. Though not illustrated, the recording layer 12 includes a three-dimensionally crosslinked polymer matrix, a radical polymerizable compound, and a photoradical polymerization initiator. A recording light 20 and a reference light 21 mutually cross in a desired position within the recording layer 12 to form interference fringes thereby recording information.

FIG. 2 is a schematic cross-sectional view showing an example of a reflective type hologram recording medium to be employed in a collinear (coaxial) holography, and a recording light and a reference light in the vicinity thereof.

A reflective hologram recording medium is provided, as shown in FIG. 2, with a first substrate 10 and a second substrate 11, a spacer 13 supported therebetween, a recording layer 12 surrounded by the spacer 13, and a reflective layer 14 provided on a surface of the second substrate 11 opposite to the side of the recording layer 12. Though not illustrated, the recording layer 12 includes a three-dimensionally crosslinked polymer matrix, a radical polymerizable compound, and a photoradical polymerization initiator. A recording light 20 and a reference light 21 are condensed by a lens 30 and focused on the surface of the reflective layer 14. In this state, the recording light 20 and the information light 21 form interference fringes in a desired position in the recording layer 12, thereby recording information.

In the foregoing, the transmission hologram recording medium is explained by a two-beam holography and the reflective hologram recording medium is explained by a collinear holography, but other combinations are also possible, such as a transmission hologram recording medium utilizing collinear holography.

In the following, components of the hologram recording medium will be explained in more details.

1) Recording Layer

The recording layer shows a rubber-like elasticity at the room temperature, and has a durometer hardness within a range of A45 to A85, preferably A50 to A80 and more preferably A55 to A75.

A hardness of A45 or higher can suppress a volumic change in the recording layer resulting from a displacement of the radical polymerizable compound, and a hardness of A85 or lower does not excessively hinder the displacement of the radical polymerizable compound, thereby maintaining the recording sensitivity and the diffraction efficiency.

The durometer hardness is measured according to JIS K 6253 (rubber hardness testing method, matching ISO 7619-1:2004 (Rubber, vulcanized or thermoplastic—Determination of indentation hardness—Part 1: Durometer method, Shore hardness)), or a test method corresponding thereto.

The recording layer includes a three-dimensionally crosslinked polymer matrix, a radical polymerizable compound and a photoradical polymerization initiator. Also additives and the like may be added suitably.

The recording layer preferably has a layer thickness within a range of 20 μm to 2 mm in view of providing a sufficient memory capacity and a high resolution. A more preferred thickness of the recording layer is within a range of 50 μm to 1 mm.

In the following, components contained in the recording layer will be explained.

1a) Three-Dimensionally Crosslinked Polymer Matrix

The three-dimensionally crosslinked polymer matrix includes a cured reaction product of a polymerizable compound which is liquid at the normal temperature, and a compound reactive to the polymerizable compound.

The polymerizable compound which is liquid at the normal temperature is preferably an epoxy compound, which can be one or more of the following examples.

Examples include 1,2,7,8-diepoxyoctane, 1,4-bis(2,3-epoxypropoxy-perfluoroisopropyl)cyclohexane, 3,4-epoxycyclohexylmethyl-3′,4′-epoxycyclohexane carboxylate, 3,4-epoxycyclohexyloxilane, 1,2-ethylenedioxy-bis(3,4-epoxycyclohexylmethane), 4′,5′-epoxy-2′-methylcyclohexylmethyl-4,5-epoxy-2-methylcyclohexane carboxylate, ethylene glycol-bis(3,4-epoxycyclohexane carboxylate), bis-(3,4-epoxycyclohexylmethyl) adipate, di-2,3-epoxycyclopentyl ether, diglycerol polyglycidyl ether, pentaerythritol polyglycidyl ether, sorbitol polyglycidyl ether, trimethylolpropane polyglycidyl ether, resorcinol diglycidyl ether, 1,6-hexanediol diglycidyl ether, polyethylene glycol diglycidyl ether, phenyl glycidyl ether, p-tert-butylphenyl glycidyl ether, dibromophenyl glycidyl ether, dibromoneopentyl glycol diglycidyl ether, 1,6-dimethylol perfluorohexane diglycidyl ether, 4,4′-bis(2,3-epoxypropoxyperfluoroisopropyl) diphenyl ether, adipic acid diglycidyl ester, o-phthalic acid diglycidyl ester, allyl glycidyl ether, and vinyl glycidyl ether.

A compound reactive to the epoxy compound as the polymerizable compound can be, for example, an amine, a phenol, an organic acid anhydride, or an amide, known as an epoxy curing agent. Specific examples include ethylenediamine, diethylenetriamine, triethylenetetramine, tetraethylenepentamine, pentaethylenehexamine, hexamethylenediamine, menthenediamine, isophoronediamine, bis(4-amino-3-methyldicyclohexyl)methane, bis(aminomethyl)cyclohexane, N-aminoethylpiperadine, m-xylilenediamine, 1,3-diamonopropane, 1,4-diaminobutane, trimethylhexamethylenediamine, iminobispropylamine, bis(hexamethylene)triamine, 1,3,6-trisaminomethylhexane, dimethylaminopropylamine, aminoethylethanolamine, tri(methylamino)hexane, m-phenylenediamine, p-phenylenediamine, diaminodiphenylmethane, diaminodiphenylsulfone, 3,3′-diethyl-4,4′-diaminodiphenylmethane, a phenol-novolac resin, a cresol-novolac resin, polyvinylphenol, a terpene-phenol resin, and a polyamide resin, while examples of an aliphatic acid anhydride include compounds to be explained later, and there is employed one or more of these compound. The compound reactive to the polymerizable compound is preferably inactive to light.

A polymerizable compound other than an epoxy compound can be an isocyanate. A compound reactive to isocyanate can be a polyol. The isocyanate can be 2,4-tolylene diisocyanate, 2,6-tolylene diisocyanate, or hexamethylene diisocyanate, and polyol can be ethylene oxide, propylene oxide, polyethylene glycol, polypropylene glycol, 1,4-butanediol or 1,6-hexanediol. Isocyanate and polyol react in the presence of a catalyst such as an organic tin compound or a tertiary amine to form a polyurethane.

1b) Radical Polymerizable Compound

The radical polymerizable compound undergoes an addition reaction by a photoradical polymerization initiator to assume a radical activity and induces a photopolymerization reaction.

The radical polymerizable compound can be a compound having an unsaturated double bond, such as an unsaturated carboxylic acid, an unsaturated carboxylate ester, an unsaturated carboxylamide or a vinyl compound.

Examples of the unsaturated carboxylic acid include acrylic acid, and methacrylic acid; those of the unsaturated carboxylate ester include methyl acrylate, ethyl acrylate, propyl acrylate, butyl acrylate, isobutyl acrylate, 2-ethylhexyl acrylate, octyl acrylate, lauryl acrylate, stearyl acrylate, cyclohexyl acrylate, bicyclopentenyl acrylate, phenyl acrylate, isobornyl acrylate, adamantyl acrylate, methyl methacrylate, propyl methacrylate, butyl methacrylate, phenyl methacrylate, phenoxyethyl acrylate, chlorophenyl acrylate, adamantyl methacrylate, isobornyl methacrylate, tribromophenyl acrylate, trichlorophenyl acrylate, tribromophenyl methacrylate, trichlorophenyl methacrylate, naphthyl methacrylate, naphthyl acrylate, bicyclopentenyl acrylate, 1,6-hexanediol diacrylate, pentaerythritol triacrylate, pentaerythritol tetraacrylate, dipentaerythritol hexaacrylate, diethylene glycol diacrylate, polyethylene glycol diacrylate, polyethylene glycol dimethacrylate, tripropylene glycol diacrylate, and propylene glycol trimethacrylate; those of unsaturated carboxylamide include N-phenylmethacrylamide, N-methylacrylamide, N,N-dimethylacrylamide, N,N′-methylenebisacrylamide, acryloylmorpholine, and N-phenylacrylamide; those of vinyl compound include vinylpyridine, styrene, bromostyrene, chlorostyrene, vinyl benzoate, 3,5-dichlorovinyl benzoate, vinylnaphthalene, vinyl naphthoate, N-vinylpyrrolidinone, N-vinylcarbazole, and 1-vinylimidazole; and those of allyl compound include diallyl phthalate and triallyl trimellitate.

The radical polymerizable compound is preferably so blended as to represent a proportion of 1 to 50 wt. % with respect to the entire recording layer in view of sufficiently increasing the refractive index of the recording area and depressing a volumic contraction thereby possibly reducing the resolution. A more preferable amount of the radical polymerizable compound is 3 to 30 wt. % with respect to the entire recording layer.

1c) Photoradical Polymerization Initiator.

The photoradical polymerization initiator assumes a radical activity by the recording light and the reference light, and executes an addition reaction to the radical polymerizable compound, thereby causing a photopolymerization reaction to be initiated.

The photoradical polymerization initiator can be a benzophenone, an organic peroxide, a thioxanthone derivative or a triazine.

Specific examples of the benzophenone include benzyl, benzoin, benzophenone, benzoin ethyl ether, benzoin isopropyl ether, benzoin butyl ether, benzoin isobutyl ether, 1-hydroxycyclohexyl phenyl ketone, benzylmethylketal, benzylethylketal, benzyl methoxyethyl ether, 2,2′-diethylacetophenone, 2,2′-dipropylacetophenone, 2-hydroxy-2-methylpropiophenone, p-tert-butyltrichloroacetophenone, and 3,3′,4,4′-tetra(t-butylperoxycarbonyl)benzophenone; those of organic peroxide include di-t-butyl peroxide, dicumyl peroxide, t-butyl cumyl peroxide, t-butyl peroxyacetate, t-butyl peroxyphthalate, t-butyl peroxybenzoate, acetyl peroxide, isobutyryl peroxide, decanoyl peroxide, lauroyl peroxide, benzoyl peroxide, t-butyl hydroperoxide, cumene hydroperoxide, methyl ethyl ketone peroxide, and cyclohexanone peroxide; those of thioxanthone derivative include thioxanthone, 1-chlorothioxanthone, 2-chlorothioxanthone, 2-isopropylthioxanthone, and 2-methylthioxanthone; and those of triazine include 2,4,6-tris(trichloromethyl)-1,3,5-triazine, 2-(p-methoxyphenyl)-4,6-bis(trichloromethyl)-1,3,5-triazine, and 2-[(p-methoxyphenyl)ethylene]-4,6-bis(trichloromethyl)-1,3,5-triazine. Also there can be employed various grades of Irgacure of Ciba Specialty Chemicals Inc., such as #149, 184, 369, 651, 784, 819, 907, 1700, 1800, and 1850.

The photoradical polymerization initiator is preferably blended in a proportion of 0.1 to 10 wt. % with respect to the radical polymerizable compound in view of providing a sufficient refractive index difference and depressing an excessive light absorption thereby providing a high resolution. A more preferred amount of the photoradical polymerization initiator is 0.5 to 6 wt. % with respect to the radical polymerizable compound.

1d) Others

In the recording layer, other additives such as a curing catalyst, a sensitizer, a defoamer, a thermal polymerization inhibitor, a colorant and a color erasing agent may be suitably added.

A curing catalyst is a component capable of promoting a curing of a reaction product of diglycidyl ether and aliphatic acid anhydride.

The curing catalyst is preferably a tertiary amine, an organic phosphine compound, or an imidazole, known as an epoxy curing catalyst.

Specific examples of tertiary amine include triethanolamine, piperidine, N,N7-dimethylpiperazine, 1,4-diazadicyclo(2,2,2) octane(triethylenediamine), pyridine, picoline, dimethylcyclohexylamine, dimethylhexylamine, benzyldimethylamine, 2 -(dimethylaminomethyl)phenol, 2,4,6-tris(dimethylaminomethyl)phenol, DBU (1,8-diazabicyclo(5,4,0-undecene-7), and a phenol salt thereof; those of organic phosphine compound include trimethylphosphine, triethylphosphine, tributylphosphine, triphenylphosphine, and tri(p-methylphenyl)phosphine; and those of imidazole compound and derivative thereof include 2-methylimidazole, 2,4-dimethylimidazole, 2-ethyl-4-methylimidazole, 2-phenylimidazole, 2-phenyl-4-methylimidazole and 2-heptaimidazole.

Also there may be employed a latent catalyst such as a trifluoroboron-amine complex, dicyanamide, an organic acid hydrazide, diaminomaleonitrile or a derivative thereof, melamine or a derivative thereof, or aminimide.

The curing catalyst is preferably added in an amount of about 0.05 to 5% with respect to the total mass of diglycidyl ether and acid anhydride.

A sensitizer is employed when the wavelength of the recording light and the reference light is different from an absorbing wavelength of the photoradical polymerization initiator. In case the recording light is a visible light, the sensitizer is often a colored compound such as a dye.

The sensitizer can be, for example, cyanine, merocyanine, xanthene, coumarine or eosin, and one or more kinds of such compound can be employed.

A defoamer is a component for removing bubbles at the preparation of a solution, and can for example be a silane coupling agent.

A thermal polymerization inhibitor is a component for suppressing a polymerization reaction by heat, thereby suppressing a decrease in the difference of the refractive index after recording.

A colorant is a component for improving absorption of the recording light and the reference light.

A color erasing agent is a component for improving a diffraction efficiency.

2) First Substrate

The first substrate has a translucency to the lights employed in recording/reproduction of hologram, such as a recording light, a reference light, a servo light etc., namely visible to near-ultraviolet light.

The first substrate can be formed by glass or a plastic material. So-called engineering plastics are preferable because of a high mechanical strength.

Specific examples of glass include soda lime glass, lead glass, borosilicate glass, and quartz glass, and those of plastics include polycarbonate resin, norbornene resin, cycloolefin resin, polyallylate, polymethyl methacrylate, polystyrene, poly(ethylene dimethylacrylate), polydiethylene glycol bis(allyl carbonate), polyphenylene oxide and polyethylene terephthalate.

The first substrate is preferably formed by a material without a birefringence.

The first substrate preferably has a thickness within a range of about 100 μm to about 1 mm.

3) Second Substrate

The first substrate has a translucency to the lights employed in recording/reproduction of hologram, such as a recording light, a reference light, a servo light etc., namely visible to near-ultraviolet light.

A material and a thickness of the second substrate are similar to those of the first substrate.

The second substrate is preferably provided, on a surface opposite the side of the recording layer, with a pregrooving for positioning. For achieving a detailed positioning, the pregrooving preferably has a pitch of projecting parts smaller than a recording shift.

Also in case of a reflective hologram recording medium, the second substrate preferably has a thickness of about 200 μm or larger. This is to reduce a power density of the recording light within the recording layer, thereby reducing a shift multiplex distance and realizing a high recording density.

4) Others

The hologram recording medium may further include a reflective layer, an intermediate layer, a protective layer, a spacer and the like.

A reflective layer is employed in a reflective hologram recording medium, and is provided on a surface of the second substrate, opposite to the side of the recording layer.

The reflective layer is preferably formed by a material having a high reflectance to the recording light, the reference light and the servo light. For example, in case the light to be used has a wavelength of about 400 to about 780 nm, there is preferably employed an Al alloy or an Ag alloy, and, in case of a wavelength of about 650 nm or longer, there is preferably employed, in addition to the Al alloy or Ag alloy, an Au alloy, a Cu alloy, or TiN.

The reflective layer preferably has a thickness of about 50 nm or larger in order to realize a sufficient reflectance, and more preferably about 100 nm or larger.

An intermediate layer is provided between the recording layer and the first substrate, or between the recording layer and the second substrate. This serves to suppress a reaction between a component of the first substrate or the second substrate and a component of the recording layer.

The intermediate layer is preferably formed by a material having a high transmittance to the recording light, the reference light and the servo light, and having a refractive index close to that of the recording layer, the first substrate and the second substrate.

Examples of the material include magnesium fluoride, calcium fluoride, zirconium fluoride, palladium fluoride, barium fluoride, cesium bromide, cesium iodide, magnesium oxide, aluminum oxide, silicon oxide, titanium oxide, chromium oxide, zinc oxide, yttrium oxide, zirconium oxide, indium oxide, tin oxide, tellurium oxide, cerium oxide, hafnium oxide, tantalum oxide, boron nitride, silicon nitride, aluminum nitride, zirconium nitride, silicon carbide, zinc sulfide, barium titanate and diamond.

A protective layer is provided on an outermost surface of the hologram recording medium.

The protective layer is preferably formed by a material having a high transmittance to the recording light, the reference light and the servo light, and having a refractive index close to that of the recording layer, the first substrate and the second substrate.

For the protective protection of the recording layer, the protective layer is preferably formed by glass, a transparent resin, or a material mentioned for the intermediate layer.

For the purpose of improving a shelf life by preventing a deterioration of the recording layer by a natural light, the protective layer is preferably provided with a film having a photobleaching function or a photochromic function showing transmittance only to the recording light. This is because the recording layer before recording is in a meta-stable state in which the monomer is dispersed, and is subject to a deterioration by a natural light. The recording layer after recording is in a stable state in which a polymerization of the radical polymerizable compound is completed corresponding to the interference fringes, and is not subject to a reduction of the archival life by the natural light.

A spacer is provided between the first substrate and the second substrate. The spacer is used for obtaining a desired thickness in the recording layer. The spacer is formed by a material having a low mutual solubility with components of the recording layer. Examples of the material include a glass plate, glass beads, Teflon (registered trade name) resin, Teflon beads and a metal plate.

5) Producing Method

There will be explained an example of a producing method for a hologram recording medium of the first embodiment.

At first the polymerizable compound which is liquid at the normal temperature, the compound reactive to the polymerizable compound, the radical polymerizable compound and the phtotoradical polymerization initiator are mixed and defoamed to prepare a recording layer precursor solution.

Then the recording layer precursor solution is coated by a casting method or a spin coating method on the first substrate or on the second substrate. It is also possible to adopt a method of positioning two glass plates with a resinous spacer therebetween and pouring the recording layer precursor solution into a gap therebetween.

Thereafter, in case a cured reaction product is not yet formed by the polymerizable compound which is liquid at the normal temperature and the compound reactive to the polymerizable compound.

### SECOND EMBODIMENT

On a hologram recording medium of the second embodiment, there will be explained points different from that of the first embodiment.

1) Recording Layer

The recording layer includes a three-dimensionally crosslinked polymer matrix, a radical polymerizable compound and a photoradical polymerization initiator.

The recording layer preferably has a layer thickness within a range of 20 μm to 2 mm in view of providing a sufficient memory capacity and a high resolution. A more preferred thickness of the recording layer is within a range of 50 μm to 1 mm.

1a) Three-Dimensionally Crosslinked Polymer Matrix

The three-dimensionally crosslinked polymer matrix includes a cured reaction product of diglycidyl ether and an aliphatic acid anhydride to be explained later.

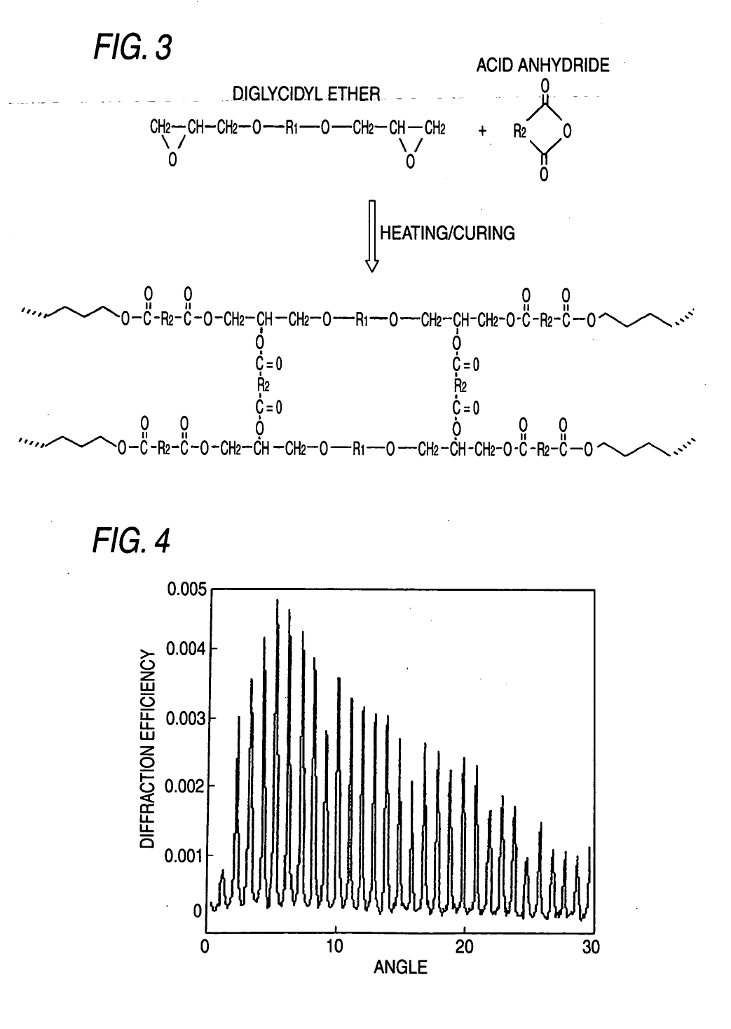

FIG. 3 is a schematic view showing a reaction of diglycidyl ether and an aliphatic acid anhydride. As shown in FIG. 3, the cured reaction product of the two becomes a three-dimensionally crosslinked polymer matrix. Naturally FIG. 3 shows the cured reaction product only in a part thereof.

As glycidyl ether, there is employed a compound of an epoxy equivalent of 100 to 300, preferably represented by a following formula 1 or 2.

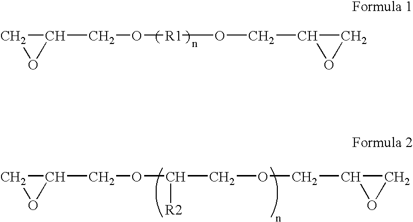

In the formulae, n represents a natural number; R1 represents a group selected from the group consisting of an ethyl group, a propylene group and a neopentylene group; and R2 represents a hydrogen atom or a methyl group.

Diglycidyl ether, due to an epoxy equivalent of 100 or higher, does not excessively prevent displacement of the radical polymerizable compound, thereby maintaining a recording sensitivity and a diffraction efficiency, and, due to an epoxy equivalent of 300 or lower, can suppress a volumic change of the recording layer resulting from the displacement of the radical polymerizable compound. The epoxy equivalent within the aforementioned range allows to easily regulate the recording layer within the aforementioned hardness range.

Also, as R1 in the formula 1 is a saturated aliphatic connecting group, diglycidyl ether has a translucency to the lights employed in recording/reproduction of hologram, such as a recording light, a reference light, a servo light etc., namely visible to near-ultraviolet light. It therefore does not hinder the optical absorption of the photoradical polymerization initiator.

Such diglycidyl ether, becoming easily liquidous at the room temperature, shows a high mutual solubility with other components and allows to easily form a uniform recording layer.

In the following formula 1, R1 preferably includes any one of a group of an ethylene group, a propylene group, a neopentylene group, an ethylene ether group and a propylene ether group. This is because such diglycidyl ether has a high translucency to the visible to near ultraviolet light and allows to prepare a recording layer of the aforementioned hardness.

Specific examples of glycidyl ether represented by the formula 1 include, for R1 constituted of a linear hydrocarbon only, ethylene glycol diglycidyl ether, 1,4-butanediol diglycidyl ether, 1,5-pentanediol diglycidyl ether, 1,6-hexanediol diglycidyl ether, 1,8-octanediol diglycidyl ether, 1,10-decanediol diglycidyl ether, and 1,12-dodecanediol diglycidyl ether; and for R1 having a hydrocarbon side chain, neopentyl glycol diglycidyl ether.

Specific examples of glycidyl ether represented by the formula 2 include diethylene glycol diglycidyl ether, tetraethylene glycol diglycidyl ether, hexaethylene glycol diglycidyl ether, octaethylene glycol diglycidyl ether, nonaethylene glycol diglycidyl ether, decaethylene glycol diglycidyl ether, and dodecaethylene glycol diglycidyl ether.

Preferred examples of diglycidyl ether include 1,4-butanediol diglycidyl ether, 1,6-hexanediol diglycidyl ether, 1,8-octanediol diglycidyl ether, diethylene glycol diglycidyl ether, polyethylene glycol diglycidyl ether, and neopentyl glycol diglycidyl ether, and particularly preferably 1,6-hexanediol diglycidyl ether.

Since such diglycidyl ether generally has a low viscosity, another glydicyl ether may be added for increasing the viscosity of the recording layer precursor solution.

Specific examples of such glydicyl ether include sorbitol tetraglycidyl ether, polyglycerol polydiglycidyl ether, pentaerythritol diglycidyl ether, pentaerythritol triglycidyl ether, pentaerythritol tetraglycidyl ether, diglycerol diglycidyl ether, diglycerol tridiglycidyl ether, diglycerol tetradiglycidyl ether, glycerol diglycidyl ether, glycerol tridiglycidyl ether, trimethylolpropane diglycidyl ether, trimethylolpropane tridiglycidyl ether, polypropylene glycol diglycidyl ether, and polybutadiene diglycidyl ether.

The aliphatic acid anhydride may be linear or cyclic.

More specifically, a linear aliphatic acid anhydride can be dodecenylsuccinic anhydride, polyadipic anhydride, polyazelaic anhydride, or polycebacic anhydrode, and a cyclic aliphatic acid anhydride can be maleic anhydride, succinic anhydride, tetrahydrophthalic anhydride, methyltetrahydrophthalic anhydride, methylnadic anhydride, hexahydrophthalic anhydride, methylhexahydrophthalic anhydride, and methylcyclohexenetetracarboxylic anhydride.

In particular, an aliphatic acid anhydride that is liquid at the room temperature is preferred in order to improve mutual solubility with other components. Specific examples include methyltetrahydrophthalic anhydride, methylhexahydrophthalic anhydride, methylnadic anhydride and dodecenylsuccinic anhydride.

A number of blended parts of the acid anhydride is represented by:
number of blended parts (by weight) of acid anhydride=C×(acid anhydride equivalent/epoxy equivalent)×100,
taking blended parts of diglycidyl ether as 100 parts by weight, and the blending is executed with C within a range of 0.7 to 1.2.

When C value falls into the above range, ithere is less influence of unreacted components and it will be easy to obtained an appropriate hardness in the recording layer.

5) Producing Method

There will be explained an example of a producing method for a hologram recording medium of the second embodiment.

At first the diglycidyl ether, the aliphatic acid anhydride, the radical polymerizable compound and the phtotoradical polymerization initiator are mixed and defoamed to prepare a recording layer precursor solution.

Then the recording layer precursor solution is coated by a casting method or a spin coating method on the first substrate or on the second substrate. It is also possible to adopt a method of positioning two glass plates with a resinous spacer therebetween and pouring the recording layer precursor solution into a gap therebetween.

Then the hologram recording medium is heated to about 50 to 150° C., preferably about 50 to 80° C., to cause a reaction of diglycidyl ether and aliphatic acid anhydride. In case of a temperature less than 50° C., diglycidyl ether and aliphatic acid anhydride may not react sufficiently whereby the hardness of the recording layer may not be elevated, and, in case of a temperature exceeding 150° C., the radical polymerizable compound may be consumed by the thermal reaction whereby a photorecording may become impossible. A heating time is preferably about 10 hours to 3 days for example at 50° C., and about 2 to 3 hours at 150° C. Particularly, the heating is preferably performed at a heating temperature of 50 to 80° C. for 24 to 48 hours.

### EXAMPLES

In the following there will be explained examples of the invention, but the present invention is not limited to such examples unless exceeding the scope of the invention.

<Preparation of Hologram Recording Medium>

### Example 1

A recording layer precursor solution was prepared in a dark room in the following manner. 15.1 g of 1,6-hexanediol diglycidyl ether (epoxy equivalent: 151, manufactured by Nagase ChemteX Co.) represented by a following formula 3 as diglycidyl ether, 26.6 g of dodecenylsuccinic anhydride as the acid anhydride, and 0.42 g of DMP-30 (2,4,6-tris(dimethylaminomethyl)phenol) as the curing catalyst were mixed, then, 10.425 g of N-vinylcarbazole as the radical polymerizable compound and 0.261 g of Irgacure 784 (manufactured by Ciba Specialty Chemicals Inc.) as the photoradical polymerization initiator were mixed and the mixture was defoamed to obtain a coating layer precursor solution.

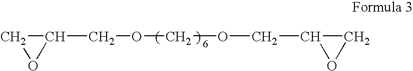

Thereafter, it was poured into a gap between first and second glass substrates positioned across a Teflon (registered trade name) sheet spacer. It was then shielded from light and heated for 24 hours in an oven of 60° C. to obtain a transmission hologram recording medium having a recording layer of a thickness of 200 μm.

### Example 2

A hologram recording medium was prepared in the same manner as in Example 1, except that N-vinylcarbazole, employed as the radical polymerizable compound, was replaced by 2,4,6-tribromophenyl acrylate.

### Example 3

A hologram recording medium was prepared in the same manner as in Example 1, except that the recording layer precursor solution was prepared in the following manner.

10.1 g of 1,4-butanediol diglycidyl ether (epoxy equivalent: 101, manufactured by Aldrich Inc.) represented by a following formula 4 as diglycidyl ether, 26.6 g of dodecenylsuccinic anhydride as the acid anhydride, and 0.37 g of DMP-30 (2,4,6-tris(dimethylaminomethyl)phenol) as the curing catalyst were mixed, then, 9.175 g of N-vinylcarbazole as the radical polymerizable compound and 0.229 g of Irgacure 784 (manufactured by Ciba Specialty Chemicals Inc.) as the photoradical polymerization initiator were mixed and the mixture was defoamed to obtain a coating layer precursor solution.

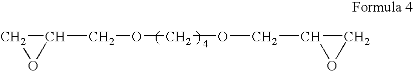

### Example 4

A hologram recording medium was prepared in the same manner as in Example 3, except that N-vinylcarbazole, employed as the radical polymerizable compound, was replaced by 2,4,6-tribromophenyl acrylate.

### Example 5

A hologram recording medium was prepared in the same manner as in Example 1, except that the recording layer precursor solution was prepared in the following manner.

10.1 g of neopentyl glycol diglycidyl ether (epoxy equivalent: 108, manufactured by Tokyo Kasei Kogyo Co.) represented by a following formula 5 as the diglycidyl ether, 26.6 g of dodecenylsuccinic anhydride as the acid anhydride, and 0.37 g of DMP-30 (2,4,6-tris(dimethylaminomethyl)phenol) as the curing catalyst were mixed, then, 9.35 g of 2,4,6-tribromophenyl acrylate as the radical polymerizable compound and 0.234 g of Irgacure 784 (manufactured by Ciba Specialty Chemicals Inc.) as the photoradical polymerization initiator were mixed and the mixture was defoamed to obtain a coating layer precursor solution.

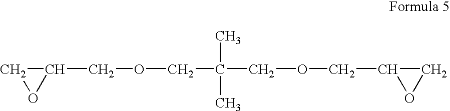

### Example 6

A hologram recording medium was prepared in the same manner as in Example 1, except that the recording layer precursor solution was prepared in the following manner.

12.2 g of diethylene glycol diglycidyl ether (epoxy equivalent: 122, manufactured by Nagase ChemteX Co.) represented by a following formula 6 as the diglycidyl ether, 26.6 g of dodecenylsuccinic anhydride as the acid anhydride, and 0.39 g of DMP-30 (2,4,6-tris(dimethylaminomethyl)phenol) as the curing catalyst were mixed, then, 9.70 g of 2,4,6-tribromophenyl acrylate as the radical polymerizable compound and 0.243 g of Irgacure 784 (manufactured by Ciba Specialty Chemicals Inc.) as the photoradical polymerization initiator were mixed and the mixture was defoamed to obtain a coating layer precursor solution.

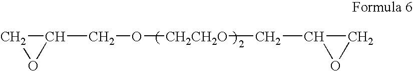

### Example 7

A hologram recording medium was prepared in the same manner as in Example 1, except that the recording layer precursor solution was prepared in the following manner.

18.7 g of polyethylene glycol diglycidyl ether (epoxy equivalent: 187, manufactured by Nagase ChemteX Co.) as the diglycidyl ether, 16.8 g of methylhexahydrophthalic anhydride as the acid anhydride, and 0.36 g of DMP-30 (2,4,6-tris(dimethylaminomethyl)phenol) as the curing catalyst were mixed, then, 8.88 g of 2,4,6-tribromophenyl acrylate as the radical polymerizable compound and 0.444 g of Irgacure 784 (manufactured by Ciba Specialty Chemicals Inc.) as the photoradical polymerization initiator were mixed and the mixture was defoamed to obtain a coating layer precursor solution.

### Example 8

A hologram recording medium was prepared in the same manner as in Example 1, except that the recording layer precursor solution was prepared in the following manner.

13.0 g of 1,8-octanediol diglycidyl ether (epoxy equivalent: 175) represented by a following formula 7 as the diglycidyl ether, 26.6 g of dodecenylsuccinic anhydride as the acid anhydride, and 0.40 g of DMP-30 (2,4,6-tris(dimethylaminomethyl)phenol) as the curing catalyst were mixed, then, 9.90 g of N-vinylcarbazole as the radical polymerizable compound and 0.248 g of Irgacure 784 (manufactured by Ciba Specialty Chemicals Inc.) as the photoradical polymerization initiator were mixed and the mixture was defoamed to obtain a coating layer precursor solution.

1,8-octanediol diglycidyl ether was synthesized by reacting 1,8-octanediol and epichlorohydrin in a DMSO solvent containing potassium hydroxide.

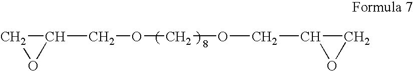

### Example 9

A hologram recording medium was prepared in the same manner as in Example 1, except that the recording layer precursor solution was prepared in the following manner.

26.8 g of polyethylene glycol diglycidyl ether (epoxy equivalent: 268, manufactured by Nagase ChemteX Co.) as the diglycidyl ether, 16.8 g of methylhexahydrophthalic anhydride as the acid anhydride, and 0.436 g of DMP-30 (2,4,6-tris(dimethylaminomethyl)phenol) as the curing catalyst were mixed, then, 10.9 g of N-vinylcarbazole as the radical polymerizable compound and 0.245 g of Irgacure 784 (manufactured by Ciba Specialty Chemicals Inc.) as the photoradical polymerization initiator were mixed and the mixture was defoamed to obtain a coating layer precursor solution.

### Example 10

A hologram recording medium was prepared in the same manner as in Example 1, except that the recording layer precursor solution was prepared in the following manner.

28.4 g of polyethylene glycol diglycidyl ether (epoxy equivalent: 284, manufactured by Nagase ChemteX Co.) as the diglycidyl ether, 16.8 g of methylhexahydrophthalic anhydride as the acid anhydride, and 0.452 g of DMP-30 (2,4,6-tris(dimethylaminomethyl)phenol) as the curing catalyst were mixed, then, 11.3 g of N-vinylcarbazole as the radical polymerizable compound and 0.254 g of Irgacure 784 (manufactured by Ciba Specialty Chemicals Inc.) as the photoradical polymerization initiator were mixed and the mixture was defoamed to obtain a coating layer precursor solution.

### Comparative Example 1

A hologram recording medium was prepared in the same manner as in Example 1, except that the recording layer precursor solution was prepared in the following manner.

8.7 g of ethylene glycol diglycidyl ether (epoxy equivalent: 87) as the diglycidyl ether, 16.8 g of methylhexahydrophthalic anhydride as the acid anhydride, and 0.25 g of DMP-30 (2,4,6-tris(dimethylaminomethyl)phenol) as the curing catalyst were mixed, then, 6.38 g of N-vinylcarbazole as the radical polymerizable compound and 0.14 g of Irgacure 784 (manufactured by Ciba Specialty Chemicals Inc.) as the photoradical polymerization initiator were mixed and the mixture was defoamed to obtain a coating layer precursor solution.

### Comparative Example 2

A hologram recording medium was prepared in the same manner as in Example 1, except that the preparation was conducted in the following manner.

In a dark room, 37.2 g of polyethylene glycol diglycidyl ether (epoxy equivalent: 372, manufactured by Nagase ChemteX Co.) as diglycidyl ether, 16.8 g of methylhexahydrophthalic anhydride as the acid anhydride, and 0.54 g of DMP-30 (2,4,6-tris(dimethylaminomethyl)phenol) as the curing catalyst were mixed, then, 13.5 g of N-vinylcarbazole as the radical polymerizable compound and 0.24 g of Irgacure 784 (manufactured by Ciba Specialty Chemicals Inc.) as the photoradical polymerization initiator were mixed and the mixture was defoamed to obtain a coating layer precursor solution.

Then it was tried to prepare a hologram recording medium by operations similar to those in Example 1, but, after heating for 24 hours in an oven of 60° C., the recording layer did not solidify but remained liquid. The recording layer was hardened by heating for further 48 hours in an oven of 80° C. thereby obtaining a hologram recording medium.

Epoxy equivalents of the examples are shown in Table 1. As diglycidyl ether is generally difficult to synthesize in a single type but is usually used as a mixture of plural types of diglycidyl ether, an epoxy equivalent value is more important than the compound name.

<Hardness Measurement Test of Recording Layer>

In a dark room, each recording layer precursor liquid of Examples 1-10 and Comparative Examples 1-2 was poured in a metal mold, then shielded from light and heated for 24 hours in an oven of 60° C. to obtain a cured substance of a thickness of 6 mm, having a rubber-like elasticity. Hardness was measured, in a dark room, by a durometer (type A) under conditions specified in JIS K 6253 (rubber hardness testing method, matching ISO 7619-1:2004). Obtained results are shown in Table 1.

<Recording/Reproduction Test of Hologram Recording Medium>

Each hologram recording medium of Examples 1-10 and Comparative Examples 1-2 was placed on a rotary stage of a two-beam holography apparatus, and subjected to a recording and a reproduction. A semiconductor laser (405 nm) was employed as a light source 1. An information light 20 and a reference light 21 had light spot sizes on the hologram recording medium of 5 mmφ each, and information recording was conducted by regulating a summed light intensity of the information light 20 and the reference light 21 at 5 mW/cm².

Thereafter, the reference light 21 alone was irradiated, and a diffracted light from the hologram recording medium was observed. A maximum diffraction efficiency and a light irradiation amount to reach the maximum diffraction efficiency are also shown in Table 1. In case the diffraction efficiency did not show a maximum even at a light irradiation amount of 1000 mJ/cm², a diffraction efficiency at a light irradiation amount of 1000 mJ/cm² was taken as the maximum diffraction efficiency.

<Angular Multiplex Recording/Reproduction Test of Hologram Recording Medium>

Also an angular multiplex recording/reproduction test was conducted on the hologram recording medium. Angular multiplex recordings of 30 pages were conducted with an exposure amount of 1 mJ/cm² per page, and a shift angle of 1 degree.

Then, after the medium was let to stand for 5 minutes for awaiting completion of the reaction, the rotary stage was put in a sweeping motion under the irradiation of the reference light 21 only, and a diffraction efficiency T was measured to obtain results as shown in FIG. 4. As the diffraction efficiency, there was employed an internal diffraction efficiency defined by a following equation:
η=I_{d}/(Iₜ+I_{d})
wherein Iₜ indicates a light intensity of the reference light at reproduction; and I_{d} indicates a light intensity of the diffracted light.

M/# and volumic contraction rate, calculated from this result, are also shown in Table 1.

In the following, methods for calculating M/# and volumic change rate will be explained.

M/# is defined by a following equation, and a larger M/# provides a larger recording dynamic range and a superior multiplex recording ability:

$$M / \# = {\sum }_{i = 1}^{n} \sqrt{η i}$$

ηi indicates, in an angular multiplex recording/reproduction of holograms of n pages, a diffraction efficiency measured from an i-th hologram, and M/# does not depend on n at a large number n of multiplexity (for example see L. Hesselink, S. S. Orlow, M. C. Bashaw, Holographic Data Storage Systems, Proceedings of SPIE, 2004, Vol. 92, pp 1231-1280).

A volumic change rate was calculated from a shift amount between an angle at recording and a peak angle of the diffraction efficiency of a reproduction signal.

TABLE 1

| | Hologram record. Med. | | | | | | | |
|---|---|---|---|---|---|---|---|---|
| | | Radical polymerisable | | Hardness | Recording- | | Angular multiplex | |
| | Diglycidyl | compound | | test of | reproduction test | | rec/repro. Test | |
| | ether | | 2,4,6- | recording | Light | max dif. | | vol. |
| | Epoxy | N-vinyl- | tribromophenyl | layer | irradiation | efficiency | | contraction |
| | equivalent | carbazole | acrylate | Hardness | J/cm² | % | M/# | rate % |
| Ex. 1 | 151 | ◯ | | A58 | 220 | 88 | 2.8 | 0.11 |
| Ex. 2 | 151 | | ◯ | A58 | 50 | 79 | 3.5 | 0.11 |
| Ex. 3 | 101 | ◯ | | A71 | 300 | 82 | 2.5 | 0.11 |
| Ex. 4 | 101 | | ◯ | A70 | 69 | 85 | 3.0 | 0.10 |
| Ex. 5 | 108 | | ◯ | A56 | 120 | 70 | 1.8 | 0.10 |
| Ex. 6 | 122 | | ◯ | A75 | 150 | 76 | 2.0 | 0.10 |
| Ex. 7 | 187 | | ◯ | A85 | 260 | 72 | 1.6 | 0.10 |
| Ex. 8 | 175 | ◯ | | A45 | 170 | 83 | 2.6 | 0.11 |
| Ex. 9 | 268 | ◯ | | A67 | 220 | 85 | 2.6 | 0.10 |
| Ex. 10 | 284 | ◯ | | A56 | 190 | 78 | 2.1 | 0.12 |
| Comp. Ex. 1 | 87 | ◯ | | A97 | 1000 | 30 | 0.2 | 0.10 |
| Comp. Ex. 2 | 372 | ◯ | | A36 | 1000 | 20 | 0.1 | 0.13 |

In Table 1, “O” indicates using the compound of N-vinyl-carbazole or 2,4,6-tribromo-phenyl acrylate.

As shown in Table 1, Examples 1-10 have higher maximum diffraction efficiencies with lower light irradiations and larger M/#, in comparison with Comparative Examples 1 and 2. It is therefore shown that a hologram recording medium having a hardness of A45 to A85 is excellent in the recording sensitivity and the diffraction efficiency.

Also as shown in Table 1, Examples 1-0.10 have higher maximum diffraction efficiencies with lower light irradiations and larger M/#, in comparison with Comparative Examples 1 and 2. It is therefore shown that a hologram recording medium including a three-dimensionally crosslinked polymer matrix utilizing diglycidyl ether of an epoxy equivalent of 101 to 284 is excellent in the recording sensitivity and the diffraction efficiency.

These examples confirmed the effect of the embodiments on diglycidyl ether of an epoxy equivalent of 101 to 284, but, based on these results, a similar effect can be anticipated on diglycidyl ether of an epoxy equivalent of 100 to 300. In a synthesis of glycidyl ether, it is generally difficult to completely remove an impurity polymer or an unreacted raw material. Therefore glycidyl ether has a distribution in molecular weight, and the epoxy equivalent represents an average value of such distribution. Therefore, even in case the epoxy equivalent shows a certain deviation from the range of examples, it is anticipated that the characteristics do not show an extreme change that similar effects can be obtained.

Also as shown in Table 1, M/# is larger in Example 1 in comparison with Examples 3, 8 and 9, and larger in Example 2 in comparison with Examples 4 to 7. It is therefore clarified that 1,6-hexanediol diglycidyl ether is superior in recording sensitivity and diffraction efficiency.

Also as shown in Table 1, Examples 1-10 have smaller volumic contraction rates in comparison with Comparative Example 2. It is therefore clarified that the hologram recording medium of the invention has a sufficient hardness, thus being capable of suppressing the volumic change in the recording layer, resulting from the displacement of the radical polymerizable compound.

<Preparation of Hologram Recording Medium>

### Example 11

A recording layer precursor solution was prepared in a dark room in the following manner. 10.1 g of 1,4-butanediol diglycidyl ether (epoxy equivalent: 101, manufactured by Aldrich Inc.) represented by the formula 4 as an ether, and 3.6 g of diethylenetriamine as an amine were mixed, then, 3.4 g of N-vinylcarbazole as the radical polymerizable compound and 0.077 g of Irgacure 784 (manufactured by Ciba Specialty Chemicals Inc.) as the photoradical polymerization initiator were mixed and the mixture was defoamed to obtain a coating layer precursor solution.

Thereafter, it was poured into a gap between first and second glass substrates positioned across a Teflon (registered trade name) sheet spacer. It was then shielded from light and heated for 24 hours at the room temperature (25° C.) to obtain a transmission hologram recording medium having a recording layer of a thickness of 200 μm.

### Example 12

A hologram recording medium was prepared in the same manner as in Example 11, except that the recording layer precursor solution was prepared in the following manner.

12.2 g of diethylene glycol diglycidyl ether (epoxy equivalent: 122, manufactured by Nagase ChemteX Co.) represented by the formula 6 as the ether, and 3.6 g of diethylenetriamine as the amine were mixed, then, 3.95 g of N-vinylcarbazole as the radical polymerizable compound and 0.089 g of Irgacure 784 (manufactured by Ciba Specialty Chemicals Inc.) as the photoradical polymerization initiator were mixed and the mixture was defoamed to obtain a coating layer precursor solution.

### Example 13

A hologram recording medium was prepared in the same manner as in Example 11, except that the recording layer precursor solution was prepared in the following manner.

15.1 g of 1,6-hexanediol diglycidyl ether (epoxy equivalent: 151, manufactured by Nagase ChemteX Co.) represented by the formula 3 as the ether, and 3.6 g of diethylenetriamine as the amine were mixed, then, 4.68 g of N-vinylcarbazole as the radical polymerizable compound and 0.105 g of Irgacure 784 (manufactured by Ciba Specialty Chemicals Inc.) as the photoradical polymerization initiator were mixed and the mixture was defoamed to obtain a coating layer precursor solution.

### Comparative Example 3

A hologram recording medium was prepared in the same manner as in Example 11, except that the recording layer precursor solution was prepared in the following manner.

7.1 g of 1,2,7,8-diepoxyoctane (epoxy equivalent: 71, manufactured by Wako Pure Chemicals Co.) as the ether, and 3.6 g of diethylenetriamine as the amine were mixed, then, 2.68 g of N-vinylcarbazole as the radical polymerizable compound and 0.060 g of Irgacure 784 (manufactured by Ciba Specialty Chemicals Inc.) as the photoradical polymerization initiator were mixed and the mixture was defoamed to obtain a coating layer precursor solution.

### Comparative Example 4

A hologram recording medium was prepared in the same manner as in Example 11, except that the recording layer precursor solution was prepared in the following manner.

10.8 g of neopentyl glycol diglycidyl ether (epoxy equivalent: 108, manufactured by Tokyo Kasei Kogyo Co.) represented by the formula 5 as the ether, and 3.6 g of diethylenetriamine as the amine were mixed, then, 3.60 g of N-vinylcarbazole as the radical polymerizable compound and 0.081 g of Irgacure 784 (manufactured by Ciba Specialty Chemicals Inc.) as the photoradical polymerization initiator were mixed and the mixture was defoamed to obtain a coating layer precursor solution.

### Comparative Example 5

A hologram recording medium was prepared in the same manner as in Example 11, except that the recording layer precursor solution was prepared in the following manner.

17.6 g of polypropylene glycol diglycidyl ether (epoxy equivalent: 176, manufactured by Nagase ChemtX Co.) as the ether, and 3.6 g of diethylenetriamine as the amine were mixed, then, 5.3 g of N-vinylcarbazole as the radical polymerizable compound and 0.119 g of Irgacure 784 (manufactured by Ciba Specialty Chemicals Inc.) as the photoradical polymerization initiator were mixed and the mixture was defoamed to obtain a coating layer precursor solution.

<Hardness measurement test of recording layer> and <Recording/reproduction test of hologram recording medium> were conducted also on Examples 11-13 and Comparative Examples 3-5. Results are shown in Table 2.

TABLE 2

| | | Recording-reproduction test | |
|---|---|---|---|
| | Hardness test of | | Max. diffraction |
| | recording layer | Light irradiation | efficiency |
| | Hardness | J/cm² | % |
| Ex. 11 | A81 | 200 | 81 |
| Ex. 12 | A77 | 120 | 83 |
| Ex. 13 | A72 | 80 | 82 |
| Comp. Ex. 3 | A88 | 1000 | 4 |
| Comp. Ex. 4 | A30 | 1000 | 10 |
| Comp. Ex. 5 | A37 | 1000 | 12 |

As shown in Table 2, Examples 11-13 have higher maximum diffraction efficiencies with lower light irradiations, in comparison with Comparative Examples 3-5. It is therefore shown that a hologram recording medium having a hardness of A45 to A85 is excellent in the recording sensitivity and the diffraction efficiency.

In the foregoing, the embodiments of the present invention has been explained, but the present invention is not limited thereto and is subject to various alterations within the scope of the invention described in the appended claims. Also the present invention can be modified in the execution thereof in various manners within such scope. Also various inventions can be attained by suitably combining plural constituent components disclosed in the aforementioned embodiments.

What is claimed is:

1. A hologram recording medium comprising
first and second translucent substrates; and
a recording layer between the first and second substrates, wherein the recording layer comprises: a three-dimensionally crosslinked polymer matrix; a radical polymerizable compound; and a photoradical polymerization initiator, and the recording layer shows a rubber-like elasticity at the room temperature and has a durometer hardness of A45 to A85.

2. The hologram recording medium as claimed in claim 1, wherein the recording layer shows a rubber-like elasticity at 25° C.

3. The hologram recording medium as claimed in claim 1, which comprises a reflective layer, wherein the second substrate is between the reflective layer and the recording layer.

4. A hologram recording medium comprising:
first and second translucent substrates; and
a recording layer between the first and second substrates, wherein the recording layer comprises: a three-dimensionally crosslinked polymer matrix comprising a cured reaction product of a diglycidyl ether having an epoxy equivalent of 100 to 300 and an aliphatic acid anhydride; a radical polymerizable compound; and a photoradical polymerization initiator.

5. The hologram recording medium as claimed in claim 4, wherein the diglycidyl ether is a compound represented by one of formula 1 and 2: 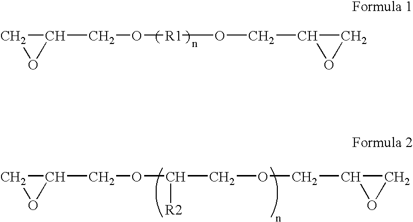
wherein n represents a natural number; R1 represents a group selected from the group consisting of an ethyl group, a propylene group and a neopentylene group; and R2 represents a hydrogen atom or a methyl group.

6. The hologram recording medium as claimed in claim 4, wherein the diglycidyl ether is a compound selected from the group consisting of 1,4-butanediol diglycidyl ether, 1,6-hexandiol diglycidyl ether, 1,8-octanediol diglycidyl ether, diethylene glycol diglycidyl ether, polyethylene glycol diglycidyl ether and neopentyl glycol diglycidyl ether.

7. The hologram recording medium as claimed in claim 4, wherein the diglycidyl ether is 1,6-hexandiol diglycidyl ether.

8. The hologram recording medium as claimed in claim 4, wherein the aliphatic acid anhydride is a compound selected from the group consisting of methyltetrahydrophthalic anhydride, methylhexahydrophthalic anhydride, methylnadic anhydride and dodecenylsuccinic anhydride

9. The hologram recording medium as claimed in claim 4, wherein the cured reaction product is a product obtained by heating a diglycidyl ether with an aliphatic acid anhydride at an temperature of 50 to 80° C. for 24 to 48 hours.

10. The hologram recording medium as claimed in claim 4, wherein the recording layer has a durometer hardness of A45 to A85.

11. The hologram recording medium as claimed in claim 10, wherein the recording layer shows a rubber-like elasticity at 25° C.

12. The hologram recording medium as claimed in claim 4, which comprises a reflective layer, wherein the second substrate is between the reflective layer and the recording layer.

13. A hologram recording medium comprising:
first and second translucent substrates; and
a recording layer between the first and second substrates, wherein the recording layer comprises: a three-dimensionally crosslinked polymer matrix comprising a cured reaction product of a diglycidyl ether and an aliphatic acid anhydride; a radical polymerizable compound; and a photoradical polymerization initiator,
wherein the recording layer shows a rubber-like elasticity at the room temperature and has a durometer hardness of A45 to A85.

14. The hologram recording medium as claimed in claim 13, wherein the diglycidyl ether has an epoxy equivalent of 100 to 300.

15. The hologram recording medium as claimed in claim 13, wherein the diglycidyl ether is 1,6-hexandiol diglycidyl ether.

16. The hologram recording medium as claimed in claim 13, wherein the recording layer shows a rubber-like elasticity at 25° C.

17. The hologram recording medium as claimed in claim 13, which comprises a reflective layer, wherein the second substrate is between the reflective layer and the recording layer.
